(19) United States
(12) Patent Application Publication
(10) Pub. No.: US 2023/0412585 A1
(43) Pub. Date: Dec. 21, 2023

(54) PROVIDING SSL CONNECTIVITY INSIDE SOFTWARE DEFINED DATACENTERS WITH HYPERCONVERGED INFRASTRUCTURE

(71) Applicant: VMWare, Inc., Palo Alto, CA (US)

(72) Inventors: Tamal Nath, Bangalore (IN); Akshay Anand, Bangalore (IN); Ravi Kumar Reddy Kottapalli, Bangalore (IN); Pranesh Advankar, Bangalore (IN)

(21) Appl. No.: 17/894,194

(22) Filed: Aug. 24, 2022

(30) Foreign Application Priority Data
Jun. 17, 2022 (IN) 202241034802

(51) Int. Cl. H04L 9/40

(52) U.S. Cl. CPC H04L 63/0823; H04L 63/1416; H04L 63/0236

(57) ABSTRACT

The present disclosure is related to devices, systems, and methods for providing SSL connectivity inside SDDCs with hyperconverged infrastructure. An example method can include configuring a primary Secure Sockets Layer (SSL) certificate on an endpoint of a hyperconverged infrastructure (HCI), configuring a secondary SSL certificate on the endpoint, securing data communicated between the endpoint and another endpoint of the HCI using the primary certificate, securing data communicated between the endpoint and the other endpoint using the secondary certificate, instead of the primary certificate, responsive to determining a fault in the primary certificate, and securing data communicated between the endpoint and the other endpoint using a new primary certificate configured on the endpoint, instead of the secondary certificate, responsive to the new primary certificate being configured on the endpoint.

### RELATED APPLICATIONS

Benefit is claimed under 35 U.S.C. 119(a)-(d) to Foreign Application Serial No. 202241034802 filed in India entitled “PROVIDING SSL CONNECTIVITY INSIDE SOFTWARE DEFINED DATACENTERS WITH HYPERCONVERGED INFRASTRUCTURE”, on Jun. 17, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for providing SSL connectivity inside SDDCs with hyperconverged infrastructure according to one or more embodiments of the present disclosure.

FIG. 2 illustrates a method for providing SSL connectivity inside SDDCs with hyperconverged infrastructure according to one or more embodiments of the present disclosure.

FIG. 3 is a diagram of a system for providing SSL connectivity inside SDDCs with hyperconverged infrastructure according to one or more embodiments of the present disclosure.

FIG. 4 is a diagram of a machine for providing SSL connectivity inside SDDCs with hyperconverged infrastructure according to one or more embodiments of the present disclosure.

### DETAILED DESCRIPTION

Embodiments described herein may provide a method, system, and machine-readable medium for providing Secure Sockets Layer (SSL) connectivity inside software defined data centers (SDDCs) with hyperconverged infrastructure. An SDDC may include multiple clusters of physical servers and each cluster may be a policy-based resource container with specific availability and performance attributes that combines compute (e.g., vSphere of VMware®), storage (vSAN of VMware®), and networking (e.g., NSX of VMware®) into a single consumable entity via different applications. For example, each cluster may correspond to one workload domain of the SDDC. The workload domain may be deployed in a virtual server rack, which may include the cluster of physical servers located across a plurality of physical racks. In another example, the workload domain may be deployed in a single physical rack.

In some examples, data associated with SDDC resources and/or components (hereinafter refer to as endpoints) may be secured using digital certificates to avoid a risk of various attacks as the applications communicate data via networks (e.g., Internet). Example endpoints may include platform services controller (PSC), vCenter (VC), NSX (a network virtualization and security platform), and the like that are offered by VMware. A digital certificate may allow the endpoints to exchange data securely over the Internet using a public key infrastructure (PKI). For instance, a PKI can establish a private and secure connection between endpoints. An SSL certificate can be validated by an end user using asymmetric encryption with a public key and a private key issued by a Certificate Authority (CA). The digital certificate may include information about the public key, information about the identity of its owner (e.g., a subject), and the digital signature of an entity that has verified the certificate's contents (e.g., an issuer). It is noted that where the singular term “certificate” is used herein, such usage may alternatively refer to a set of certificates, commonly known as a “certificate set.”

In some examples, there can be various endpoints that are communicating with each other in the SDDCs with hyperconverged infrastructure. However, occasionally, certificates may fail. In some cases, such failure is unexpected and without notice. Certificate failure, as referred to herein, is the inability for a formerly-functional certificate to secure data. Failure can occur when a certificate malfunctions. Failure can occur when a certificate expires. Failure can occur when a certificate is revoked by the CA. In some embodiments, revocation may be caused by the certificate being involved in a security breach (e.g., by an attacker). A certificate revocation list (CRL) is a list of digital certificates that have been revoked by the issuing certificate authority (CA) before their actual or assigned expiration date. It is a type of block-list that includes certificates that should no longer be trusted and are used by various endpoints, including web browsers, to verify if a certificate is valid and trustworthy. This CRL file is signed by the certificate authority to prevent tampering. Certificate revocation is the act of invalidating a TLS/SSL before its scheduled expiration date. A certificate should be revoked immediately when its private key shows signs of being compromised. It should also be revoked when the domain for which it was issued is no longer operational. Once a certificate is revoked, the client can receive an error notification (e.g., CERTIFICATE_REVOCATION_ERROR) while making (e.g., attempting to make) an HTTPS connection.

In previous approaches, if a certificate fails communication can be hampered, resulting in downtime for an end user. The downtime may be due to the regeneration and/or replacement of the failed certificate so that communication may resume. In some instances, such downtime can be on the order of multiple days.

Embodiments herein can reduce the downtime caused by certificate failure. In some embodiments, the end user may experience no downtime at all. As discussed in more detail below, embodiments of the present disclosure can configure a secondary “backup” certificate on HCI endpoints in addition to a standard primary certificate. Normally, SSL communication is carried out as usual using the primary certificate. However, when the primary certificate fails (e.g., is revoked), SSL communication can automatically fall back to the secondary certificate until the primary certificate is regenerated or replaced with a new primary certificate. Then, the secondary certificate can resume its position as the backup certificate until needed again. In some embodiments, the secondary certificate can be referred to as a “lightweight” certificate. Stated differently, the secondary certificate may be provided by a lesser-known CA, may have a smaller key size than the primary certificate, and/or may have a weaker algorithm than the primary certificate. A lightweight certificate may be substantially less expensive than a primary certificate. That is, embodiments herein may be more cost effective than using an additional primary certificate as a backup.

Embodiments herein can utilize a lightweight certificate as the secondary certificate without sacrificing security. In some embodiments, for instance, the secondary certificate may be configured on a different network port (hereinafter referred to simply as “port”) of the endpoint(s) than the primary certificate. As known to those of skill in the art, a port can be represented by a number (e.g., from 0 through 1023) used to identify a network service on a private IP network or the public Internet. Residing in a field in the TCP or UDP header, the port number directs packets to the appropriate application in the server. Port 80, for example, identifies HTTP traffic for a Web server. By configuring the secondary certificate on a second port, embodiments herein can leverage various manners of limiting port access to provide security despite using a lightweight secondary certificate. For example, the port number of the second port may not be exposed externally. In some embodiments, access to the second port may be limited to specific Internet Protocol (IP) addresses and/or specific Uniform Resource Locator (URL) patterns.

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

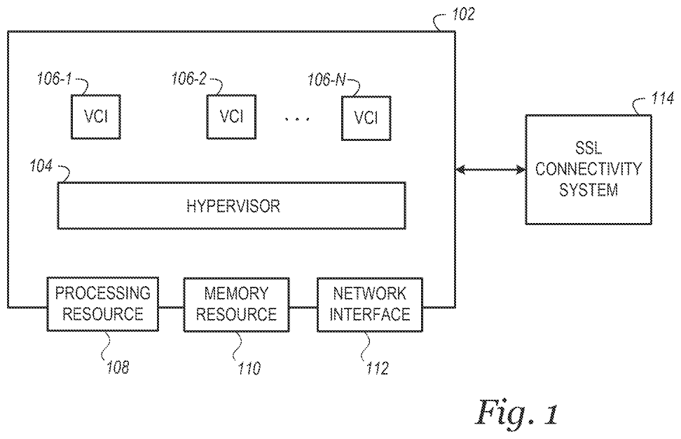

FIG. 1 is a diagram of a host and a system for providing SSL connectivity inside SDDCs with hyperconverged infrastructure according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with an SSL connectivity system 114. An example of the SSL connectivity system 114 is illustrated and described in more detail below. In some embodiments, the SSL connectivity system 114 can be a server, such as a web server. In some embodiments, the SSL connectivity system 114 can refer to an SDDC manager. An SDDC Manager appliance can be deployed in the management domain for creating workload domains, provisioning additional virtual infrastructure, and life cycle management of the SDDC management components. In some embodiments, an SDDC Manager is deployed as a preconfigured virtual appliance that is running the VMware Photon™ operating system. SDDC Manager can provide the management interface to VMware Cloud Foundation.

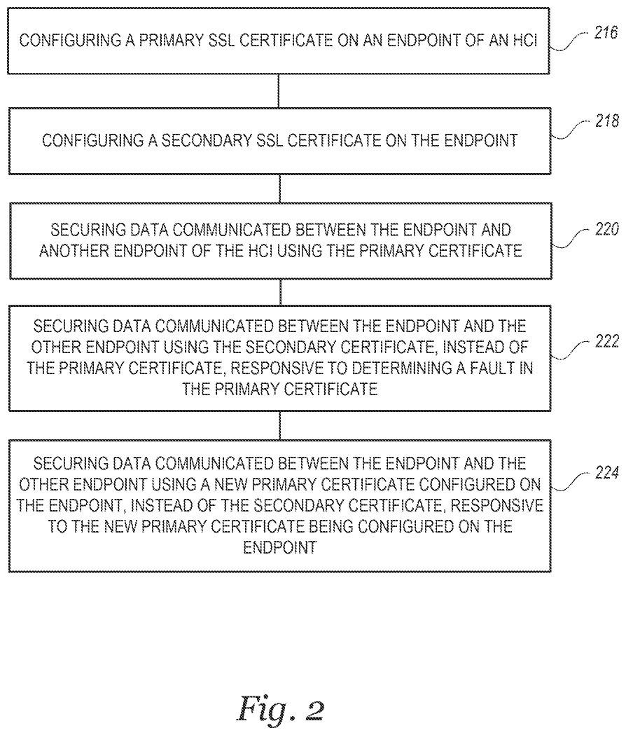

FIG. 2 illustrates a method for providing SSL connectivity inside SDDCs with hyperconverged infrastructure according to one or more embodiments of the present disclosure. The method can include, at 216, configuring a primary SSL certificate on an endpoint of an HCI. In some embodiments, the primary certificate has a key of 2048 bits. In some embodiments, the primary certificate has a key of 4096 bits. The primary certificate may be issued by any suitable CA (e.g., VeriSign, Google Certificate Authority, etc.). The primary certificate can be configured on a first endpoint port.

The method can include, at 218, configuring a secondary SSL certificate on the endpoint. The secondary certificate may be issued by any suitable CA. In some embodiments, the secondary certificate is issued by a same CA as the primary certificate. In some embodiments, the secondary certificate is issued by a different CA than the primary certificate. In some embodiments, the secondary certificate can be referred to as a “lightweight” certificate. In some embodiments, the secondary certificate is provided by a lesser-known CA than the primary certificate. In some embodiments, the secondary certificate is not signed by a third-party CA. In some embodiments, the secondary certificate has a smaller key size than the primary certificate. For instance, the secondary certificate may have a key of fewer than 2048 bits. In some embodiments, the secondary certificate has a weaker algorithm than the primary certificate. In some embodiments, the secondary certificate chain used in the alternate server name indication (SNI) may be less strong. As a result, the secondary certificate may be substantially less expensive than a primary certificate. In some embodiments, the secondary certificate has a longer lifespan than the primary certificate. That is, the secondary certificate may be valid for a longer period of time than the primary certificate.

The secondary certificate can be configured on a second endpoint port. That is, the secondary certificate can be configured on a different port than the primary certificate. By configuring the secondary certificate on a second port, embodiments herein can leverage various manners of limiting port access to provide security despite using a lightweight secondary certificate. In some embodiments, the port number of the second port is not exposed externally (e.g., outside of the HCI). Some embodiments limit exposure to the port number of the second port to local endpoints of the HCI. In some embodiments, access to the second port is limited to specific Internet Protocol (IP) addresses. For instance, access can be allowed or denied based on a particular IP address or the range of IP addresses of client computers. To allow or deny access, for instance, “allow” and/or “deny” directives can be sued inside the stream context or a server block. In some embodiments, access can be allowed or denied based on a partial IP address, a network/netmask pair, or a network/nnn CIDR specification. Either IPv4 or IPv6 addresses may be used. In some embodiments, access to the second port is limited to specific Uniform Resource Locator (URL) patterns. For instance, “address” is a fully qualified domain name (or a partial domain name); a user may provide multiple addresses or domain names, if desired.

The method includes, at 220, securing data communicated between the endpoint and another endpoint of the HCI using the primary certificate. The method includes, at 222, securing data communicated between the endpoint and the other endpoint using the secondary certificate, instead of the primary certificate, responsive to determining a fault in the primary certificate. In some embodiments, a polling mechanism can be run to identify whether the primary certificate was revoked or has otherwise failed causing the SSL connection to be broken. Failure can cause the secondary certificate (rather than the primary) to instead be used to secure data communicated between endpoints. Stated differently, when the primary certificate fails, all SSL communication will fall back to the secondary certificate. In some embodiments, a notification can be sent to all endpoints of the HCI to begin using the secondary certificate instead of the first certificate. The endpoints can be informed to switch secure communication (with the secondary certificate) to the second port. A chain of the secondary certificate can be pre-seeded to the SDDC manager (e.g., SSL connectivity system 114, previously described in connection with FIG. 1) so that the SDDC manager trusts the certificate chain before it is needed.

The method can include, at 224, securing data communicated between the endpoint and the other endpoint using a new primary certificate configured on the endpoint instead of the secondary certificate, responsive to the new primary certificate being configured on the endpoint. The new primary certificate can be similar in performance to the primary certificate. That is, in some embodiments, the new primary certificate has a key of 2048 bits. In some embodiments, the new primary certificate has a key of 4096 bits. The new primary certificate may be issued by any suitable CA (e.g., VeriSign, Google Certificate Authority, etc.). The new primary certificate can be configured on the first endpoint port or on a third endpoint port. The new primary certificate can be used until it fails, and the secondary certificate replaces it in a manner similar to that discussed with respect to the primary certificate above. When another new primary certificate is configured, the secondary certificate can again return to “backup” status. Stated differently, the method can include securing data communicated between the endpoint and the other endpoint using the secondary certificate, instead of the new primary certificate, responsive to determining a fault in the new primary certificate, and configuring another new primary SSL certificate and securing data communicated between the endpoint and the other endpoint using the other new primary certificate instead of the secondary certificate.

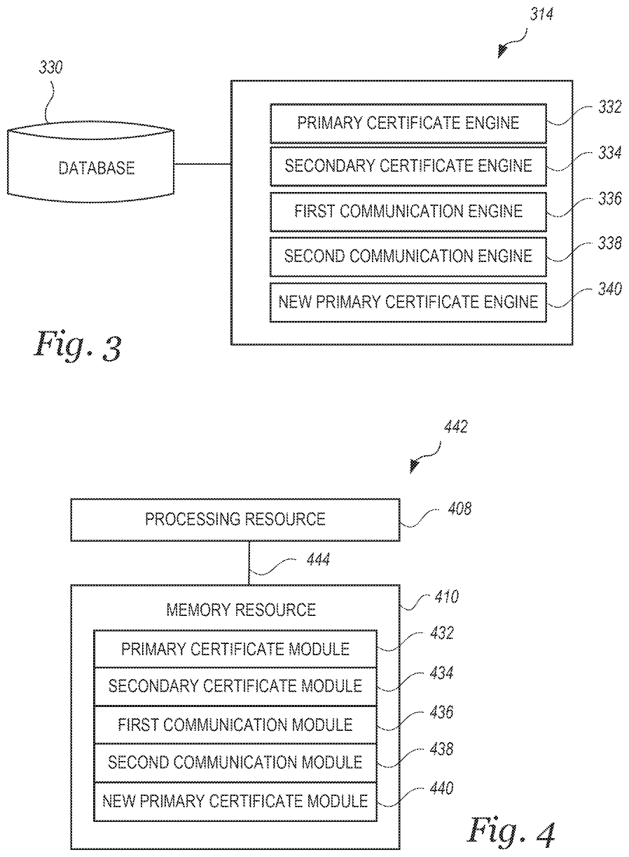

FIG. 3 is a diagram of a system 314 for providing SSL connectivity inside SDDCs with hyperconverged infrastructure according to one or more embodiments of the present disclosure. The system 314 can include a database 330 and/or a number of engines, for example first certificate engine 332, second certificate engine 334, first communication engine 336, second communication engine 338, and/or third certificate engine 340, and can be in communication with the database 330 via a communication link. The system 314 can include additional or fewer engines than illustrated to perform the various functions described herein. The system can represent program instructions and/or hardware of a machine (e.g., machine 442 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the primary certificate engine 332 can include a combination of hardware and program instructions that is configured to configure a primary SSL certificate on an endpoint of an HCI. In some embodiments, the secondary certificate engine 334 can include a combination of hardware and program instructions that is configured to configure a secondary SSL certificate on the endpoint. In some embodiments, the first communication engine 336 can include a combination of hardware and program instructions that is configured to secure data communicated between the endpoint and another endpoint of the HCI using the primary certificate. In some embodiments, the second communication engine 338 can include a combination of hardware and program instructions that is configured to secure data communicated between the endpoint and the other endpoint using the secondary certificate, instead of the primary certificate, responsive to determining a fault in the primary certificate. In some embodiments, the new primary certificate engine 340 can include a combination of hardware and program instructions that is configured to secure data communicated between the endpoint and the other endpoint using a new primary certificate configured on the endpoint, instead of the secondary certificate, responsive to the new primary certificate being configured on the endpoint.

FIG. 4 is a diagram of a machine for providing SSL connectivity inside SDDCs with hyperconverged infrastructure according to one or more embodiments of the present disclosure. The machine 442 can utilize software, hardware, firmware, and/or logic to perform a number of functions. The machine 442 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 442 (e.g., the machine 442 can include internal memory resources and have access to external memory resources). In some embodiments, the machine 442 can be a virtual computing instance (VCI). The program instructions (e.g., machine-readable instructions (MRI)) can include instructions stored on the MRM to implement a particular function (e.g., an action such as configuring a certificate, as described herein). The set of MRI can be executable by one or more of the processing resources 408. The memory resources 410 can be coupled to the machine 442 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 444. The communication path 444 can be local or remote to the machine 442. Examples of a local communication path 444 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 444 can be such that the memory resources 410 are remote from the processing resources 408, such as in a network connection between the memory resources 410 and the processing resources 408. That is, the communication path 444 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 432, 434, 436, 438, 440 that when executed by the processing resources 408 can perform a number of functions. As used herein a module includes a set of instructions included to perform a particular task or action. The number of modules 432, 434, 436, 438, 440 can be sub-modules of other modules. For example, the secondary certificate module 434 can be a sub-module of the primary certificate module 432 and/or can be contained within a single module. Furthermore, the number of modules 432, 434, 436, 438, 440 can comprise individual modules separate and distinct from one another. Examples are not limited to the specific modules 432, 434, 436, 438, 440 illustrated in FIG. 4.

Each of the number of modules 432, 434, 436, 438, 440 can include program instructions and/or a combination of hardware and program instructions that, when executed by a processing resource 408, can function as a corresponding engine as described with respect to FIG. 3. For example, the primary certificate module 432 can include program instructions and/or a combination of hardware and program instructions that, when executed by a processing resource 408, can function as the primary certificate engine 332, though embodiments of the present disclosure are not so limited.

The machine 442 can include a primary certificate module 432, which can include instructions to configure a primary SSL certificate on an endpoint of an HCI. The machine 442 can include a secondary certificate module 434, which can include instructions to configure a second SSL certificate on the endpoint. The machine 442 can include a first communication module 436, which can include instructions to secure data communicated between the endpoint and another endpoint of the HCI using the primary certificate. The machine 442 can include a second communication module 438, which can include instructions to secure data communicated between the endpoint and the other endpoint using the secondary certificate, instead of the primary certificate, responsive to determining a fault in the primary certificate. The machine 442 can include a new primary certificate module 440, which can include instructions to secure data communicated between the endpoint and the other endpoint using a new primary certificate configured on the endpoint, instead of the secondary certificate, responsive to the new primary certificate being configured on the endpoint.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 408 in FIG. 4. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
configuring a primary Secure Sockets Layer (SSL) certificate on an endpoint of a hyperconverged infrastructure (HCI);
configuring a secondary SSL certificate on the endpoint;
securing data communicated between the endpoint and another endpoint of the HCI using the primary certificate;
securing data communicated between the endpoint and the other endpoint using the secondary certificate, instead of the primary certificate, responsive to determining a fault in the primary certificate; and
securing data communicated between the endpoint and the other endpoint using a new primary certificate configured on the endpoint, instead of the secondary certificate, responsive to the new primary certificate being configured on the endpoint.

2. The method of claim 1, wherein the method includes:
configuring the primary certificate on a first port of the endpoint; and
configuring the secondary certificate on a second port of the endpoint.

3. The method of claim 2, wherein the method includes limiting access to the second port to a particular set of Internet Protocol (IP) addresses.

4. The method of claim 1, wherein the method includes limiting exposure to a port number of the second port of the endpoint to local endpoints of the HCI.

5. The method of claim 1, wherein a key size of the secondary certificate is exceeded by a key size of the primary certificate and a key size of the new primary certificate, and wherein a lifespan of the secondary certificate exceeds a lifespan of the primary certificate and a lifespan of the new primary certificate.

6. The method of claim 1, wherein the method includes:
securing data communicated between the endpoint and the other endpoint using the secondary certificate, instead of the new primary certificate, responsive to determining a fault in the new primary certificate; and
configuring another new primary SSL certificate and securing data communicated between the endpoint and the other endpoint using the other new primary certificate instead of the secondary certificate.

7. The method of claim 1, wherein determining the fault in the primary certificate includes determining that:
the primary certificate was involved in a security breach;
the primary certificate expired; or
the primary certificate malfunctioned.

8. A non-transitory machine-readable medium having instructions stored thereon which, when executed by a processor, cause the processor to:
configure a primary Secure Sockets Layer (SSL) certificate on an endpoint of a hyperconverged infrastructure (HCI);
configure a secondary SSL certificate on the endpoint;
secure data communicated between the endpoint and another endpoint of the HCI using the primary certificate;
secure data communicated between the endpoint and the other endpoint using the secondary certificate, instead of the primary certificate, responsive to determining a fault in the primary certificate; and
secure data communicated between the endpoint and the other endpoint using a new primary certificate configured on the endpoint, instead of the secondary certificate, responsive to the new primary certificate being configured on the endpoint.

9. The medium of claim 8, including instructions to:
configure the primary certificate on a first port of the endpoint; and
configure the secondary certificate on a second port of the endpoint.

10. The medium of claim 9, including instructions to limit access to the second port to a particular set of Internet Protocol (IP) addresses.

11. The medium of claim 8, including instructions to limit exposure to a port number of the second port of the endpoint to local endpoints of the HCI.

12. The medium of claim 8, wherein a key size of the secondary certificate is exceeded by a key size of the primary certificate and a key size of the new primary certificate, and wherein a lifespan of the secondary certificate exceeds a lifespan of the primary certificate and a lifespan of the new primary certificate.

13. The medium of claim 8, including instructions to:
secure data communicated between the endpoint and the other endpoint using the secondary certificate, instead of the new primary certificate, responsive to determining a fault in the new primary certificate; and
configure another new primary SSL certificate and secure data communicated between the endpoint and the other endpoint using the other new primary certificate instead of the secondary certificate.

14. The medium of claim 8, wherein the instructions to determine the fault in the primary certificate include instructions to determine that:
the primary certificate was involved in a security breach;
the primary certificate expired; or
the primary certificate malfunctioned.

15. A system, comprising:
a primary certificate engine configured to configure a primary Secure Sockets Layer (SSL) certificate on an endpoint of a hyperconverged infrastructure (HCI);
a secondary certificate engine configured to configure a secondary SSL certificate on the endpoint;
a first communication engine configured to secure data communicated between the endpoint and another endpoint of the HCI using the primary certificate;
a second communication engine configured to secure data communicated between the endpoint and the other endpoint using the secondary certificate, instead of the primary certificate, responsive to determining a fault in the primary certificate; and
a new primary certificate engine configured to secure data communicated between the endpoint and the other endpoint using a new primary certificate configured on the endpoint, instead of the secondary certificate, responsive to the new primary certificate being configured on the endpoint.

16. The system of claim 15, wherein:
the primary certificate engine is configured to configure the primary certificate on a first port of the endpoint; and
the secondary certificate engine is configured to configure the secondary certificate on a second port of the endpoint.

17. The system of claim 16, wherein the secondary certificate engine is configured to limit access to the second port to a particular set of Internet Protocol (IP) addresses.

18. The system of claim 15, wherein the secondary certificate engine is configured to limit exposure to a port number of the second port of the endpoint to local endpoints of the HCI.

19. The system of claim 15, wherein a key size of the secondary certificate is exceeded by a key size of the primary certificate and a key size of the new primary certificate, and wherein a lifespan of the secondary certificate exceeds a lifespan of the primary certificate and a lifespan of the new primary certificate.

20. The system of claim 15, wherein:
The second communication engine is configured to secure data communicated between the endpoint and the other endpoint using the secondary certificate, instead of the new primary certificate, responsive to determining a fault in the new primary certificate; and
another new primary certificate engine is configured to configure another new primary SSL certificate and secure data communicated between the endpoint and the other endpoint using the other new primary certificate instead of the secondary certificate.
